(19) United States
(12) Patent Application Publication
(10) Pub. No.: US 2002/0099524 A1
(43) Pub. Date: Jul. 25, 2002

(54) Process and system for designing a customized artistic element package

(75) Inventors: William D. Sell, St. Paul, MN (US); Bradley R. Ray, Woodbury, MN (US)

Correspondence Address: Attention: Harold C. Knecht III, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/766,853

(22) Filed: Jan. 19, 2001

Related U.S. Application Data
(60) Provisional application No. 60/208,138, filed on May 31, 2000.

(51) Int. Cl. G06F 17/50

(52) U.S. Cl. 703/1

(57) ABSTRACT

A process and system are provided for designing and manufacturing a customized artistic element package to be applied to a vehicle. The system comprises computer apparatus, input apparatus, a monitor and apparatus for producing the order. The computer apparatus includes memory for storing a plurality of initial artistic element representations and at least one representation of a vehicle. The input apparatus is coupled directly to the computer apparatus for permitting one or more of the initial artistic element representations to be selected for placement on the vehicle representation. The input apparatus further permits a customized artistic element package to be designed using the selected one or more initial artistic element representations, and additionally permits an electronic order for the package to be generated for sending directly to an artistic elements manufacturer. The monitor is coupled to the computer apparatus for displaying the selected one or more initial artistic element representations placed on the vehicle representation.

### RELATED APPLICATIONS

This application claims the benefit of U.S. Provisional Patent Application Serial No. 60/208,138, filed May 31, 2000.

### TECHNICAL FIELD

The present invention relates generally to the custom design and creation of artistic elements, such as graphics or the like, for application to vehicles or the like, and more particularly, to a process and system that allows a purchaser to select, customize and manipulate representations of graphics using a computer at a location remote from the artistic element manufacturer for later manufacture.

### BACKGROUND OF THE INVENTION

The Internet comprises a vast number of computers and computer networks that are interconnected through communication links. The interconnected computers exchange information using, for example, the World Wide Web (“WWW”), which allows a server computer system (i.e., Web server or Web site) to send graphical pages of information or Web site information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request. The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of instructions that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various instructions that control the displaying of text, graphics, controls, and other features.

The World Wide Web is especially conducive to engage in conducting electronic commerce. Many Web servers have been developed through which vendors can advertise and sell products. The products sold are typically delivered through conventional distribution channels. Hence, a server computer system may provide an electronic version of a catalog listing the items that are available for purchase. A potential purchaser may thus browse through the catalog using a browser and select various items for purchasing. When the user has completed selecting the items to be purchased, the server computer system prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

In the past, some server computer systems have allowed a potential customer to customize a product prior to ordering it. For many items, however, customization by the customer is not practical. This is usually because the cost of producing customized products is excessive. Also, the manufacturer is usually unable to produce the special or custom order in an efficient and timely manner.

### SUMMARY OF THE INVENTION

A system and process for allowing a user to design, preferably interactively, a customized artistic element package comprising one or more dimensional graphics and/or flat graphics to be applied to a vehicle is provided. One hallmark of the system and process is the ability of a customer to design interactively a customized artistic element package that can then be produced in an efficient and low cost manner. Thus, for example, when the customized artistic element package is ordered concurrently with a vehicle, the system is capable of producing the package for shipment to the vehicle manufacturer just in time to be applied to the vehicle prior to completion of the vehicle at the manufacturing plant. For instance, when the vehicle is an automobile, the package can typically be produced, shipped and received by the automobile manufacturer within about five days of placement of the order.

In accordance with a first aspect of the present invention, a system is provided for designing a customized artistic element package for application to a vehicle. The system comprises computer apparatus, input apparatus and at least one monitor. The computer apparatus includes memory for storing a plurality of initial artistic element representations and at least one representation of a vehicle. The input apparatus is coupled to the computer apparatus for permitting one or more of the initial artistic element representations to be selected for placement on the vehicle representation. At least one monitor is coupled to the computer apparatus for displaying the selected one or more initial artistic element representations placed on the vehicle representation. The input apparatus further permits one or more final artistic element representations to be designed with input from a person using the selected one or more initial artistic element representations. The one or more final artistic element representations define a customized artistic element package.

Preferably, the computer apparatus stores a plurality of vehicle representations in the memory such that a desired one of the vehicle representations may be selected via the input apparatus for viewing on the monitor. The input apparatus is preferably capable of generating appropriate command signals to the computer apparatus to permit one of the selected one or more initial artistic element representations to be moved and/or rotated on the vehicle representation and have its shape and/or size modified. Additionally, the input apparatus may permit an order for the artistic element package to be generated. In one embodiment, the computer apparatus electronically transmits print file and, preferably, purchaser identification information for the order to an artistic elements manufacturer. The print file information may comprise one or more high-resolution print files which correspond to the one or more finalized artistic elements. For an individual or private user, the purchaser identification information comprises the name and address of the purchaser. For a dealership, the purchaser information comprises dealer identification information and vehicle identification information. The vehicle identification information may be used in identifying and tracking the order. The input apparatus is also capable of generating appropriate command signals to the computer apparatus to input a request for pricing information for the package prior to generating the order.

Each of the one or more final artistic element representations may comprise the one or more initial artistic element representations placed at one or more predefined locations on the vehicle such that the one or more initial artistic element representations are located at the one or more predefined locations on the vehicle representation when initially selected and placed on the vehicle representation.

In accordance with a second aspect of the present invention, a system is provided for designing and manufacturing a customized artistic element package to be applied to a vehicle. The system comprises computer apparatus, input apparatus, at least one monitor and apparatus for producing the order. The computer apparatus includes memory for storing a plurality of initial artistic element representations and at least one representation of a vehicle. The input apparatus is coupled to the computer apparatus for permitting one or more of the initial artistic element representations to be selected for placement on the vehicle representation. The input apparatus further permits a customized artistic element package to be designed using the selected one or more initial artistic element representations, and additionally permits an electronic order for the package to be generated. The at least one monitor is coupled to the computer apparatus for displaying the selected one or more initial artistic element representations placed on the vehicle representation.

In one version of this embodiment, the computer apparatus comprises an operator computer and a server computer system. The operator computer is provided with a browser and coupled to the input apparatus and the monitor. The customized artistic element package is designed using the operator computer. The server computer system includes memory for storing web site information including the plurality of initial artistic element representations and the at least one vehicle representation. The server system is capable of downloading the web site information to the operator computer for viewing by an operator who may generate a custom order as previously described. The operator computer is, in turn, capable of sending print file information for the order to the server computer system, as well as receiving one or more customer-generated print files and transmitting the one or more customer-generated print files to the server system. Preferably, the operator computer is located at one of a vehicle dealership, an after-market detailer, and the residence of an individual purchaser.

The computer apparatus may further comprise an artistic elements manufacturer computer system capable of being interconnected with the server system. The server system sends the print file information for the order to the artistic elements manufacturer computer system after receiving the print file information from the operator computer. The artistic elements manufacturer computer system preferably comprises a file server, a raster image processor and a printer processor coupled to a printer. The file server includes memory for storing a plurality of high-resolution print files. The file server receives the print file information from the server system. The print file information identifies one or more high-resolution print files which correspond to one or more final artistic element representations defining the customized package. The file server retrieves the one or more corresponding high-resolution print files from memory and provides the same to the raster image processor. The raster image processor converts the one or more high-resolution print files into one or more bit-mapped images. The printer processor receives the one or more bit-mapped images from the raster image processor and generates print commands for the printer to create the one or more bit-mapped images on a base substrate layer.

Preferably, the artistic elements manufacturer computer system further includes a print streamer disc array coupled to the printer processor. This array is capable of receiving and storing sufficient bit-mapped image data so as to permit the printer to print continuously a plurality of the bit-mapped images on at least 23,000 inches of the base substrate layer.

The computer apparatus may further comprise a vehicle manufacturer computer system. This system is capable of being interconnected with the server system. After receiving the order from the operator computer, the server system then sends purchaser and final artistic element representation information for the order to the vehicle manufacturer computer system.

In accordance with an alternate version of the system, the computer apparatus comprises a workstation computer coupled to the input apparatus and the monitor. The workstation computer includes the memory for storing the plurality of representations of initial artistic elements and the at least one representation of a vehicle. This computer apparatus is capable of receiving one or more customer-generated print files as well. Preferably, the print files comprise one or more high-resolution print files. The print files may be transmitted to the computer apparatus from a customer computer system.

The apparatus for producing the order may comprise applying apparatus and cutting apparatus. The applying apparatus applies a protective layer on a first printed surface of a printed base substrate layer to produce a graphic substrate. The protective layer serves to protect the first printed surface from outdoor exposure, ultra-violet light, solvent spills and the like. The cutting apparatus cuts the graphic substrate to separate one or more finalized artistic elements from a remaining portion of the graphic substrate. In this embodiment, the one or more separated, finalized elements comprises one or more flat graphics. Apparatus for printing is further provided and preferably comprises a Xeikon Printer as described below. The apparatus for cutting is preferably an electronic cutter, suitable examples of which are manufactured by Aristo or Zünd (see below).

Preferably, the base substrate layer has an adhesive-backed surface. When such a base substrate layer is employed, the apparatus for producing the order may further comprise apparatus for applying a release liner over the adhesive back surface of the base substrate layer, usually prior to printing. It is also contemplated that the apparatus for producing the order may comprise apparatus for applying a controlled adhesion product over the protective layer, as well as apparatus for removing the remaining portion of the graphic substrate from the one or more finalized elements after cutting.

To facilitate cutting, the printing apparatus may print registration indicia on the base substrate layer for each of one or more finalized artistic elements. Upon locating and identifying the registration indicia for a finalized artistic element printed on the base substrate layer, the cutting apparatus automatically cuts the substrate to separate the finalized artistic element from the remaining portions of the substrate.

The cutting apparatus may comprise a cutting bed adapted to receive the graphic substrate; a cutter; a positioning apparatus coupled to the cutter for at least one of moving the cutter relative to the cutting bed, moving the cutting bed relative to the cutter, and moving the cutter and the cutting bed relative to each other; and a cutter processor coupled to the positioning apparatus for providing movement commands to the positioning apparatus to effect the cutting of the graphic substrate to separate the one or more finalized artistic elements from the remaining portion of the graphic substrate.

The apparatus for applying a protective layer on the first printed surface of the printed base substrate layer to produce the graphic substrate comprises one of a spray-line apparatus in a substantially clean environment, a screen-printing apparatus, and an apparatus for applying a substantially clear film having a pressure-sensitive adhesive thereon.

In accordance with a third aspect of the present invention, a process is provided for generating an order for a customized artistic element package to be applied to a vehicle. The process comprises the steps of: creating a database of a plurality of initial artistic element representations and at least one representation of a vehicle; selecting one or more of the initial artistic element representations for placement at one or more locations on the vehicle representation; displaying on at least one monitor the selected one or more initial artistic element representations placed on the vehicle representation; designing interactively with a person a customized artistic element package using the selected one or more initial artistic element representations; and generating an order for the artistic element package.

The process may further comprise the steps of creating a data base of a plurality of vehicle representations and selecting one of the vehicle representations for receiving the one or more initial artistic element representations.

The designing step may comprise moving one of the one or more selected initial artistic element representations to another location on the selected vehicle representation, rotating one of the one or more selected initial artistic element representations, modifying the size or shape of one of the one or more selected initial artistic element representations and/or clipping one of the one or more selected initial artistic element representations.

The order is preferably electronically transmitted to an artistic elements manufacturer. The transmitted order may comprise print file information for one or more final artistic element representations defining the customized artistic element package including information regarding placement of the one or more finalized artistic elements on the vehicle and, optionally, one or more scale factors, and purchaser identification information including vehicle identification information and dealership identification information.

In accordance with a fourth aspect of the present invention a process is provided for designing and manufacturing a customized artistic element package to be applied to a vehicle. The process comprises creating a database of a plurality of initial artistic element representations and at least one representation of a vehicle; selecting one or more of the initial artistic element representations for placement at one or more locations on the vehicle representation; displaying on at least one monitor the selected one or more initial artistic element representations placed on the vehicle representation; designing interactively with a person a customized artistic element package using the selected one or more initial artistic element representations; generating an order for the artistic element package; and producing the artistic element package.

The step of producing the package may comprise the steps of printing onto a first side of a base substrate layer graphical information for each of one or more finalized artistic elements defining the customized package to produce a first printed surface; applying a protective layer on the first printed surface of the base substrate layer to produce a graphic substrate; and cutting the graphic substrate to separate the one or more finalized artistic elements from a remaining portion of the graphic substrate. The one or more separated, finalized elements comprises one or more flat graphics.

Preferably, the base substrate layer has an adhesive-backed surface and the step of producing the package further comprises the steps of applying a release liner over the adhesive back surface of the base substrate layer and applying a controlled adhesion product over the protective layer. In one embodiment, the base substrate layer has a releasable adhesive back surface that permits the one or more separated, finalized elements to be easily removed after being applied to a vehicle.

Additionally, the process may further comprise the step of forwarding the order to an artistic elements manufacturer, who then produces the order. The order may comprise print file information and purchaser identification information, such as a vehicle identification number, for identifying and tracking the order. Preferably, the order is generated at one of a vehicle dealership, an after-market detailer, and the residence of an individual purchaser. It is contemplated that the order may be generated and the artistic element package produced within five days.

In first, second and third embodiments of the present invention, the order is generated at a vehicle dealership and the process further comprises the step of forwarding the order for the artistic element package to a vehicle manufacturer together with an order for a vehicle. In the first embodiment, the process further comprises the step of shipping the produced artistic element package from the artistic elements manufacturer to the vehicle manufacturer for application of the produced package to the ordered vehicle at the vehicle manufacturer. In the second embodiment, the process further comprises the steps of shipping the produced artistic element package to the vehicle manufacturer, and shipping the ordered vehicle with the produced artistic element package to the dealership such that the artistic element package can be applied to the ordered vehicle at the dealership. In the third embodiment, the process further comprises the step of shipping the produced artistic element package to the dealership for application of the ordered package to the ordered vehicle at the dealership. Payment for the order may be made directly to the dealership or to the artistic elements manufacturer. When payment is made to the dealership, it is made at one of the time when the vehicle is ordered and received.

It is also contemplated that the order may be generated at one of a vehicle dealership and the residence of an individual purchaser. In either case, the process further comprises the step of forwarding the order for the artistic element package to a vehicle manufacturer together with an order for a vehicle. In these embodiments, the order for the package is forwarded from the vehicle manufacturer directly to an artistic elements manufacturer. The vehicle manufacturer may make payment directly to the artistic elements manufacturer.

### BRIEF DESCRIPTION OF THE DRAWINGS

FIG. 1a is a schematic diagram illustrating one embodiment of a system for interactively designing a customized artistic element package;

FIG. 1b is a screen shot showing a plurality of vehicle representations in “thumbnail” form;

FIG. 1c is a screen shot showing the selected vehicle, along with a device for allowing the user to select a particular color of vehicle for representation;

FIG. 1d illustrates the selected vehicle representation in the selected color;

FIG. 1e is another screen shot showing the options that may be available to the user regarding the artistic element representations;

FIG. 1f is a screen shot showing a plurality of artistic element representations and the selected vehicle representation;

FIG. 1g is a screen shot similar to FIG. 1f, but showing a selected artistic element representation in place on the selected vehicle representation;

FIG. 1h is a screen shot similar to FIG. 1g, but showing a different selected artistic element representation in place on the same selected vehicle representation;

FIG. 1i is schematic diagram showing print file information;

FIG. 2a is a schematic diagram showing a second embodiment of the system for creating a customized artistic element package including an apparatus for producing an order;

FIG. 2b is a schematic diagram showing an embodiment of the system wherein the order is transmitted to a server computer system over a computer network and then forwarded in whole or in part to an artistic elements manufacturer computer system;

FIG. 2c is a screen shot similar to FIG. 1b showing the browser;

FIG. 2d is a schematic diagram showing the artistic elements manufacturer computer system;

FIG. 3a is a flow chart showing the process for producing a flat graphic;

FIG. 3b is a schematic diagram of the apparatus for cutting the graphic(s) from a base substrate layer;

FIG. 4a is a schematic diagram of the graphic substrate including a base substrate layer and a release liner; and

FIG. 4b is a schematic diagram of the graphic substrate further including a protective layer.

### DETAILED DESCRIPTION OF THE INVENTION

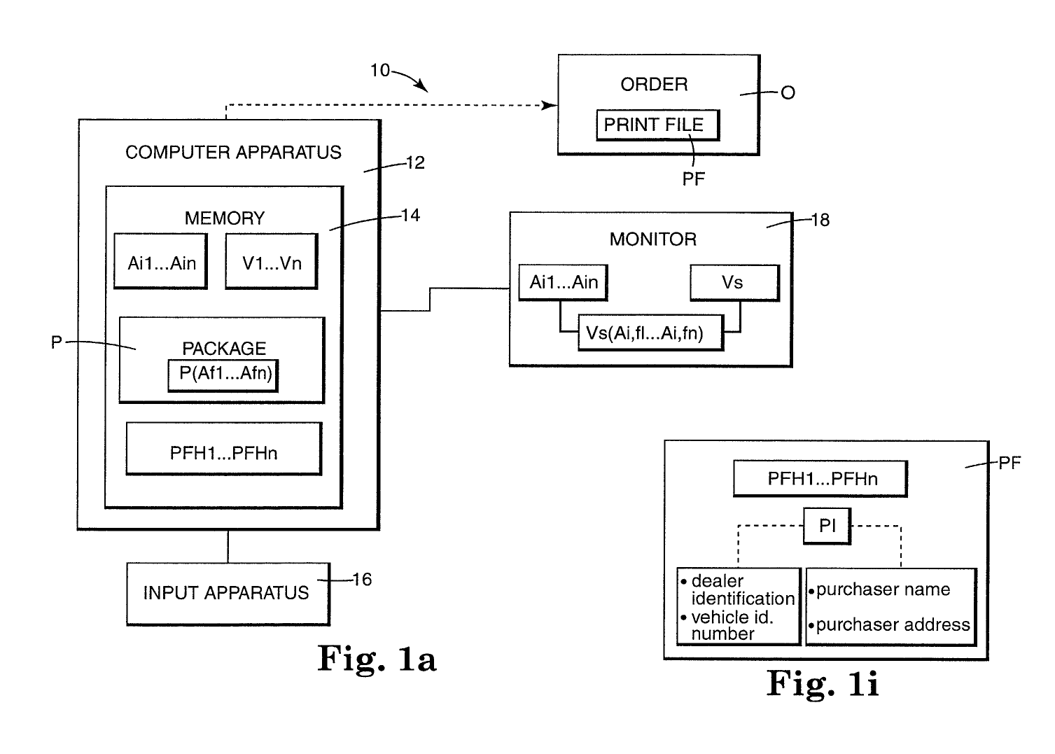

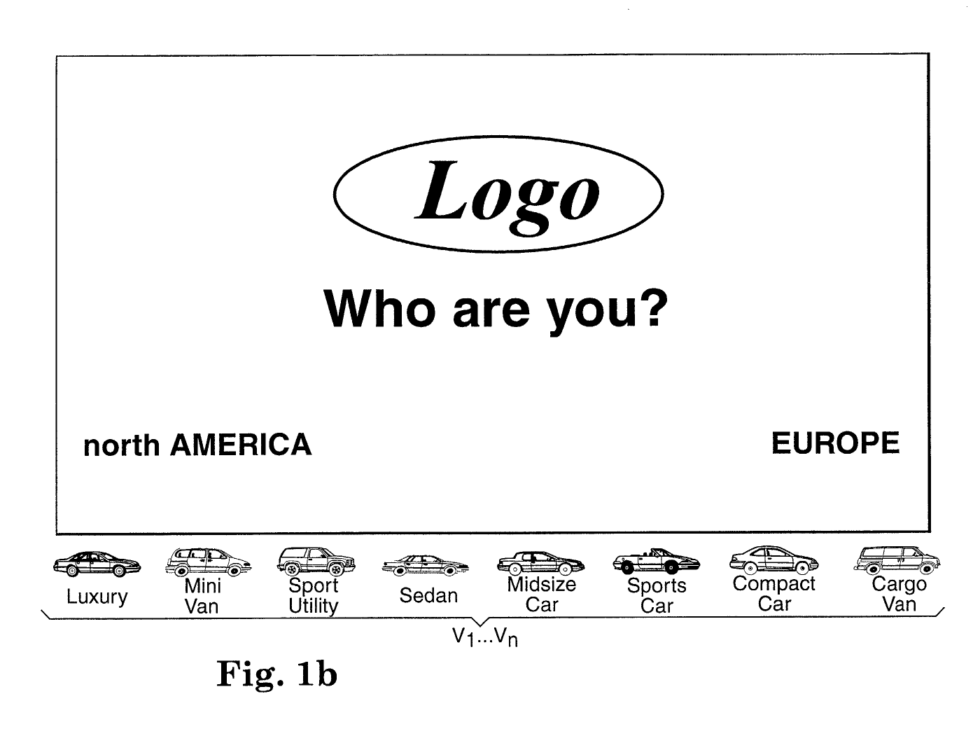

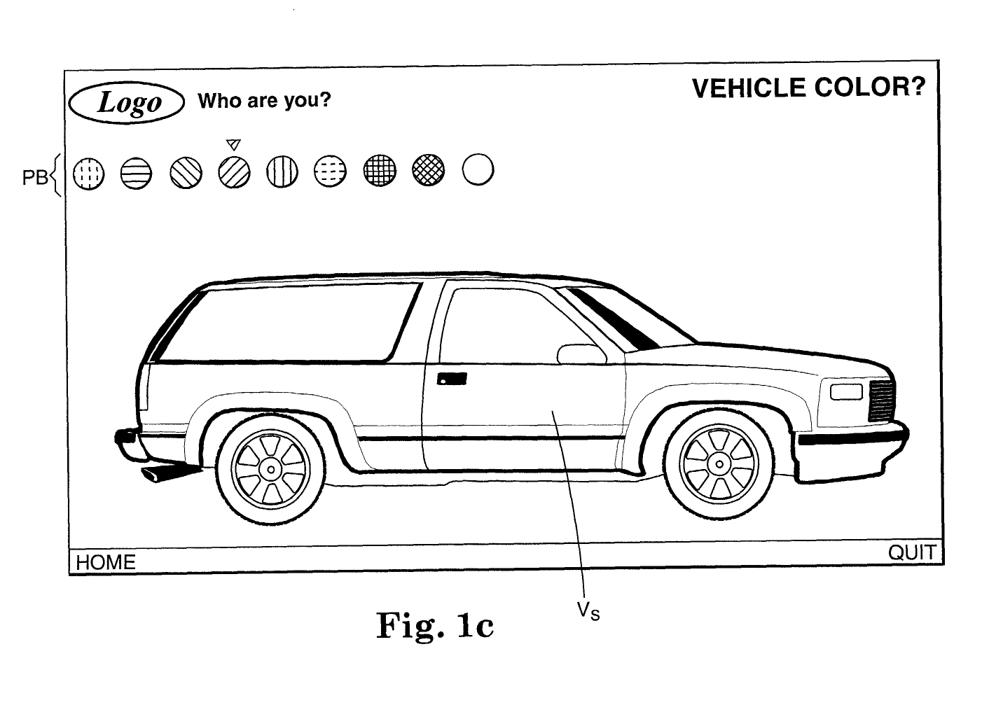

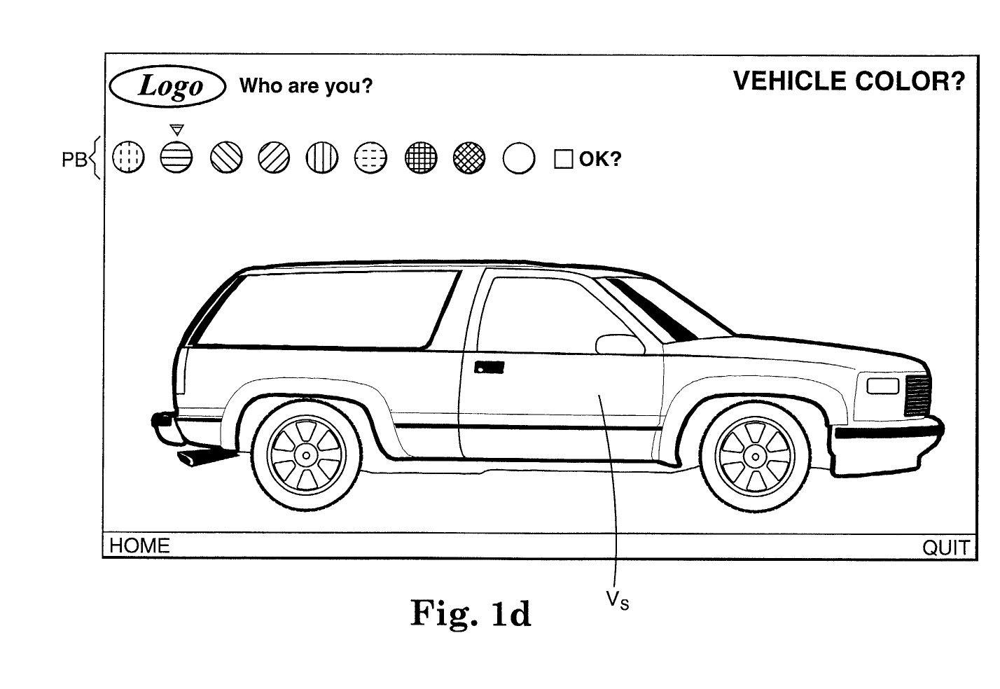

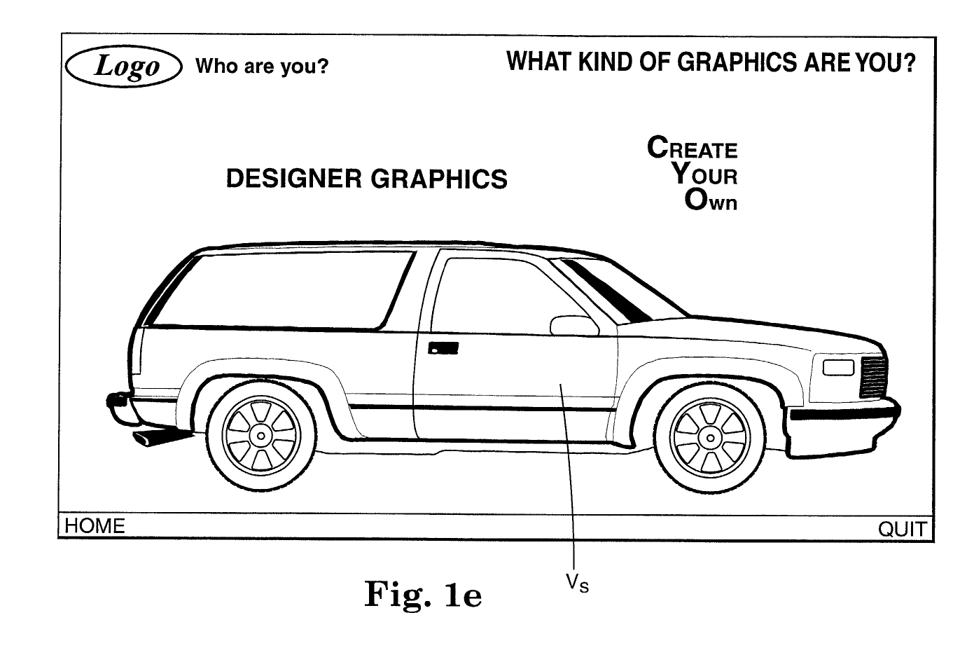

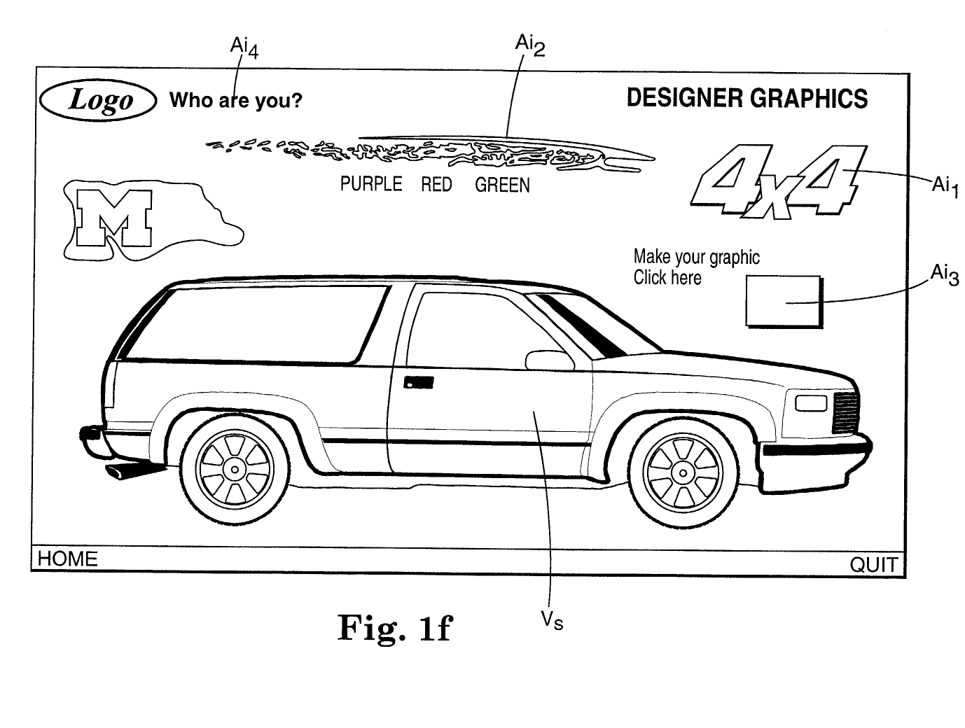

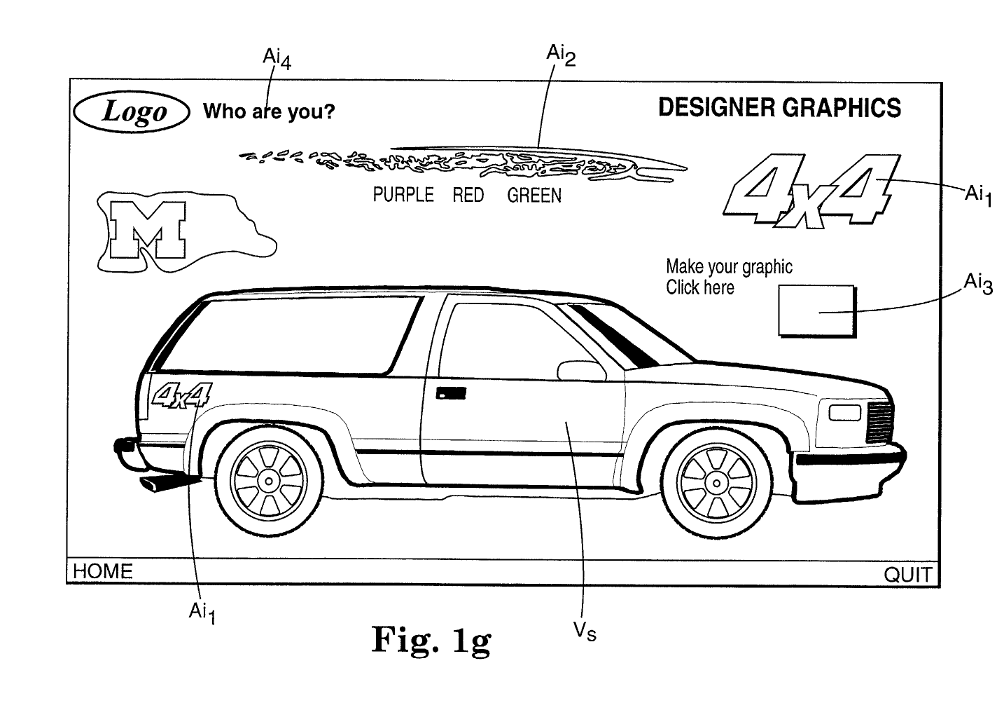

Reference is now made to FIG. 1a, which is a schematic diagram illustrating one embodiment of a system 10 for allowing an operator (also referred to as a user, customer or purchaser herein) to design a customized artistic element package comprised of one or more of dimensional graphics and/or flat graphics to be applied to a vehicle. At the outset, it is noted that the term “vehicle” as used herein may include an automobile, truck, motorcycle, boat or other watercraft, aircraft, and the like. “Dimensional graphic” as used herein means a decorative or identifying graphic made by constructing letters or figures via a molding or casting process. These letters and figures protrude above the vehicle surface and the identification characteristic results at least partially from their shape. “Flat graphic” as used herein means a graphic produced by printing the decorative or identifying element on a sheet of film. The film may include a pressure sensitive adhesive or the like for securing the graphic to a vehicle. However, when this “flat” graphic is applied to the surface of the vehicle, no “dimensional” elements protrude above the surface of the film. Instead, the identification characteristic is printed on the film as a surface indicia.

In this first embodiment, as shown in FIG. 1a, the system 10 comprises a computer apparatus 12 (also referred to herein as a workstation computer) including a memory 14 for storing a plurality of initial artistic element representations Ai₁ . . . Aiₙ, as well as at least one, and preferably a plurality of vehicle representations V₁ . . . Vₙ. The artistic element representations Ai₁ . . . Aiₙ are comprised of image data representing dimensional graphics, flat graphics, or the like. As explained above, a “dimensional graphic,” is a decorative or identifying graphic made by constructing letters or figures via a molding or casting process, whereas a “flat graphic,” means a graphic produced by printing the decorative or identifying element on a sheet of film. Despite this description of two types of graphics, it should be appreciated that in its broadest aspects, the system 10 of the present invention as well as the process described below may be used with other types of graphics or like structures as well. As should be appreciated, the artistic elements Ai₁ . . . Aiₙ may represent words, letters, symbols, emblems, logos, patterns, sweeps, swooshes, stripes, pictures, or any other type of visually perceptible artwork (for examples, see FIG. 1f and the description that follows).

An input apparatus 16 also forms a part of the system 10 to permit the user to interact with the computer apparatus 12. This input apparatus 16 may take the form of one of any number of well-known devices for interacting with a computer apparatus, such as a keyboard, mouse, a combination of both, or like input devices. To display the data representing the artistic element representations Ai₁ . . . Aiₙ and the vehicle representations V₁ . . . Vₙ (preferably in sequence, as described below), a monitor 18 or other visual display device is also coupled to the computer apparatus 12. It is also possible to combine the input apparatus 16 with the monitor 18, such as by using a touch-sensitive monitor 18 that allows the customer to interact with the computer apparatus 12 simply by touching the screen thereof using either a finger or implement, such as a specialized pen.

When a plurality of vehicle representations V₁ . . . Vₙ are provided, the input apparatus 16 (preferably a mouse (not shown)) is used to select one of the vehicle representations Vs for viewing on the monitor 18 (see FIG. 1c). In this first embodiment (see FIG. 1b), the vehicle representations V₁ . . . Vₙ represent various models of automobiles produced by the same maker, but it should be appreciated that any types or models of vehicles could be represented instead (i.e., various sport-utility vehicles produced by different makers). In this embodiment, the vehicle representations V₁ . . . Vₙ are graphically displayed as “thumbnail” views. Each thumbnail view typically includes a miniaturized graphical representation of the vehicle, along with other indicia (words, numbers, or symbols) indicating which vehicle is represented (e.g., “Explorer 4-Door”). As should be appreciated, it is of course possible to merely identify the vehicles by name or other indicia alone, rather than represent them graphically.

Once the “thumbnail” for the desired vehicle representation is selected, this representation Vₛ is displayed on the monitor 18 in an enlarged format (see FIG. 1c). At that time, the user may also be prompted by the computer apparatus 12 to input or select the desired color of vehicle, such as by using input apparatus 16 to select or “click” on one of a plurality of colors provided in a graphical representation of a palette box PB or the like. Upon doing so, the selected vehicle representation Vₛ is displayed in the selected color on the monitor 18 (see FIG. 1d, illustrating the selected vehicle representation Vₛ in white). The user may then be prompted to confirm that the color and vehicle selections are proper, such as by clicking on an “OK” or “NEXT” button (see the top of FIG. 1d adjacent to the palette box PB). As also shown in FIGS. 1c and 1d, separate buttons may also be provided to allow the user to return to a “home” screen, a previous screen, or to quit the application altogether.

As shown in the “screen shot” of FIG. 1e, once the vehicle representation Vₛ is shown in the desired color and the user has confirmed that the color and vehicle selections are proper, the computer apparatus 16 causes the monitor 18 to display various options regarding the artistic element representations, such as whether the customer wishes to select from a plurality of previously designed initial artistic element representations Ai₁ . . . Aiₙ or design one or more of his/her own artistic element representations. In this embodiment, the vehicle and previously designed initial artistic element representations are preferably stored in memory 14, which may comprise RAM, a permanent or removable disk, tape, CD-ROM, or other storage media (but as described below, the representations may also be stored at a remote server and downloaded to a local computer forming a part of the computer apparatus 12). Alternatively, the customer may input a particular artistic element representation (i.e., from clip art or the like, or from a separate database supplied by the artistic elements manufacturer) into the computer apparatus 12 or create his/her own artistic element representation, such as by using any type of commercially-available computer program for creating such representations. This program may also be linked directly to the particular computer program employed to query the user and graphically represent the artistic element/vehicle representations (preferably a Web browser using HTML, see below). It is also contemplated that an artistic element representation created by a user or his agent may be supplied to the computer apparatus 12 via a conventional storage device such as a CD-ROM or other appropriate storage device.

In the case where the former option (previously designed artistic element representations are used) is selected by the user via the input apparatus 16, the computer apparatus 12 then causes the monitor 18 to display the available one or more initial artistic element representations Ai₁ . . . Aiₙ and the selected vehicle representation Vₛ together on the same screen (see FIG. 1f). In the illustrated embodiment, only four artistic element representations are shown (Ai₁, Ai₂, Ai₃, Ai₄), and thus there is sufficient space on the monitor 18 to display them all concurrently along with the selected vehicle representation Vₛ. However, where space is limited, or a large number of artistic element representations are available, each may instead be represented as a “thumbnail” view. Alternatively, as is well known in the art, the thumbnail views or lists of available artistic element representations may be grouped and provided within one or more separate windows that may be selectively opened and closed, with each window preferably containing common themes of artistic element representations (i.e., swooshes, stripes, college logos, etc.).

In any case, the user selects one or more of the initial artistic element representations Ai₁ . . . Aiₙ for temporary placement at a predefined location on the selected vehicle representation Vₛ using the input apparatus 16. For example, as shown in FIG. 1g, the user has selected an initial “4×4” artistic element representation Ai₁ such that it is located on the rear quarter panel of the selected vehicle representation Vₛ. The placement may occur as the result of selecting the artistic element representation Ai₁ and then using the input apparatus 16 to “drag” or move it (or a copy of it) to the desired location on the selected vehicle representation Vₛ which thus creates a “composite” representation Vₛ(Ai₁ . . . Aiₙ ) (see FIG. 1a). Alternatively, placement may be “automatic,” such as by simply selecting (or “clicking on” in the case of a mouse) a particular artistic element representation Ai₁ . . Aiₙ , which then automatically moves to a predetermined location on the selected vehicle representation Vₛ. As should be appreciated, this opportunity for temporary placement allows the user to simulate the actual appearance of the vehicle in the selected color with the selected artistic element representation Ai₁ (see FIG. 1g). The “virtual” nature of this operation also allows the user then to remove this initial artistic element representation Ai₁ and then select a different artistic element representation, such as the “swoosh” pattern Ai₂, for placement on the selected vehicle representation Vₛ (see FIG. 1h). Alternatively, multiple artistic element representations Ai₁ . . . Aiₙ, may be simultaneously placed on the same selected vehicle representation Vₛ, at different locations (not shown).

Upon reviewing a selected artistic element representation Ai₁ in place on the selected vehicle representation Vₛ, either alone or together with other representations, the user/purchaser may decide it is necessary to adjust the size or shape of the representation, to cut a portion of the representation such as a “drop shadow” away, to rotate the representation about a particular axis or to move the artistic element representation Ai₁ to another location on the vehicle representation. To permit this operation, the input apparatus 16 is capable of allowing the user to manipulate the initial artistic element representation Ai₁ selected. More specifically, the input apparatus 16 in response to user/customer input generates appropriate command signals to the computer apparatus 12 to permit one of the selected one or more initial artistic element representations Ai₁ . . . Aiₙ to be moved, rotated, reshaped, or resized on the selected vehicle representation Vₛ. For instance, as is known in the art, the computer apparatus 12 may include an “electronic” tool box or kit that allows the user to select a particular graphically-represented “tool” using the input apparatus 16 for manipulating one or more of the initial artistic element representations Ai₁ . . . Aiₙ. An example of one such tool is a graphical object or symbol representing cross-hairs that, upon being placed by the user at a particular location on a selected artistic element representation Ai₁ , defines a desired center axis of rotation for that representation. Then, by manipulating the input apparatus 16 after clicking the mouse on a point spaced from that axis, the user may rotate that point and, hence, the selected artistic element representation Ai₁ about the axis of rotation until the desired amount of rotation is achieved, at which time the representation may be fixed in the desired position. As should be appreciated, the operation is particularly useful when the initial artistic element representations Ai₁ . . . Aiₙ, comprise abstract artistic element representations, such as the “swoosh” pattern identified as artistic element representation Ai₂ in FIG. 1g. Other tools may include electronic “cutters” that allow for the selected artistic element representation to be cropped or deformable windows that allow for scaling or resizing. Of course, it is also possible to use other types of electronic image manipulating tools, examples of which are well known in the art. It is also contemplated that moving an artistic element representation Ai₁ may be effect by “clicking” on the artistic element representation with the input apparatus 16 and “dragging” it to a new location on the vehicle representation Vₛ.

Once one or more initial artistic element representations Ai₁ . . . Aiₙ have been selected and, if desired, modified such that one or more of the representations are repositioned, rotated, sized, shaped and/or cut, the input apparatus 16 is commanded by the user to send a signal to the computer apparatus 12 indicating that the task at hand is completed. It is contemplated that one or more initial artistic element representations may not be modified whatsoever by the user/purchaser and hence will be positioned, shaped and sized in an unmodified form on the vehicle representation Vₛ when the signal is sent to the computer apparatus 12 indicating that the task at hand is completed. After the completion signal is sent to the computer apparatus 12, one or more “final” artistic element representations Af₁ . . . Af_{f} are generated corresponding to the selected, and possibly modified, one or more initial artistic elements Ai₁ . . . Aiₙ and stored in memory 14 (see FIG. 1a). These one or more final artistic element representations Af₁ . . . Af_{f} define a customized artistic element package P (see FIG. 1a).

Returning now to FIG. 1a, in addition to allowing a user to select and manipulate the initial artistic element representations Ai₁ . . . Aiₙ and place these representations on the selected vehicle representation Vₛ, the input apparatus 16 may allow the user to generate and send an order O for the customized artistic element package P, such as to an artistic element manufacturer or the like for producing the actual graphics for placement on the actual vehicle (see below). More specifically, the user may be prompted to enter information regarding whether placing an order O for the particular artistic element package P is desired, such as by clicking on an electronic “order” button displayed on the monitor. When instructed to create an order O, the computer apparatus 12 electronically generates print file information PF as well as final placement information specifying where each final artistic element is to be located on the vehicle. As shown schematically in FIG. 1i, the print file information PF may comprise one or more individual print files PFH₁ . . . PFHₙ that are stored in memory 14 which may contain high-resolution data corresponding to the one or more finalized artistic elements Af_{f} . . . Afₙ forming the package P. Information on the particular user, which is called “purchaser identification information,” or PI, is typically sent with the one or more individual print files and final placement information. This PI information is either stored on the computer apparatus 12 or inputted at that time by the user/purchaser using input apparatus 16 prior to sending the order O. For an individual user, the purchaser identification information typically includes, at a minimum, the name and address of the user (see FIG. 1i). For a commercial entity, such as a vehicle (automobile) dealership, the purchaser information PI usually comprises dealer identification information and vehicle identification information, such as a vehicle identification number (VIN). In either case, this purchaser information may be used in identifying and tracking the order O upon receipt, during manufacturing by the artistic elements manufacturer, and during subsequent shipping, if necessary.

Once complete, the order O may be sent from the computer apparatus 12 to an artistic elements manufacturer, such as by placing it on a disk or other medium for storing electronic files and sending it via mail or other courier. Alternatively, depending on the size of the accompanying print file information PF, as well as the available bandwidth and any server restrictions, the order O may be transmitted directly to the artistic elements manufacturer at a particular electronic address over the Internet using any known type of connection (i.e., a cable line, telephone line, or over a satellite-based or cellular network).

In addition to generating an order O, and usually prior to doing so, the computer apparatus 12 is also preferably capable of generating pricing information for the particular custom package P created by the user. This may involve making a determination of the number, size, shape, and colors in the one or more final artistic element representations Af₁ . . . Af_{f} . To obtain pricing information, the user may generate appropriate command signals using the input apparatus 16. This ability to generate pricing information allows the user to estimate the total cost of the package P prior to transmitting the order O to the manufacturer. Also, as part of the ordering process, the user may be requested to input information on the manner of paying for the order (i.e., a credit card number, electronic debit account, or the like). In the situation where the user is placing an order for a new vehicle at the same time, or the dealer or other business is placing the order for the user, it of course may not be necessary to provide payment information, since the artistic elements manufacturer may simply bill the particular vehicle manufacturer, dealer, or other entity for payment, who in turn bills the user/purchaser accordingly.

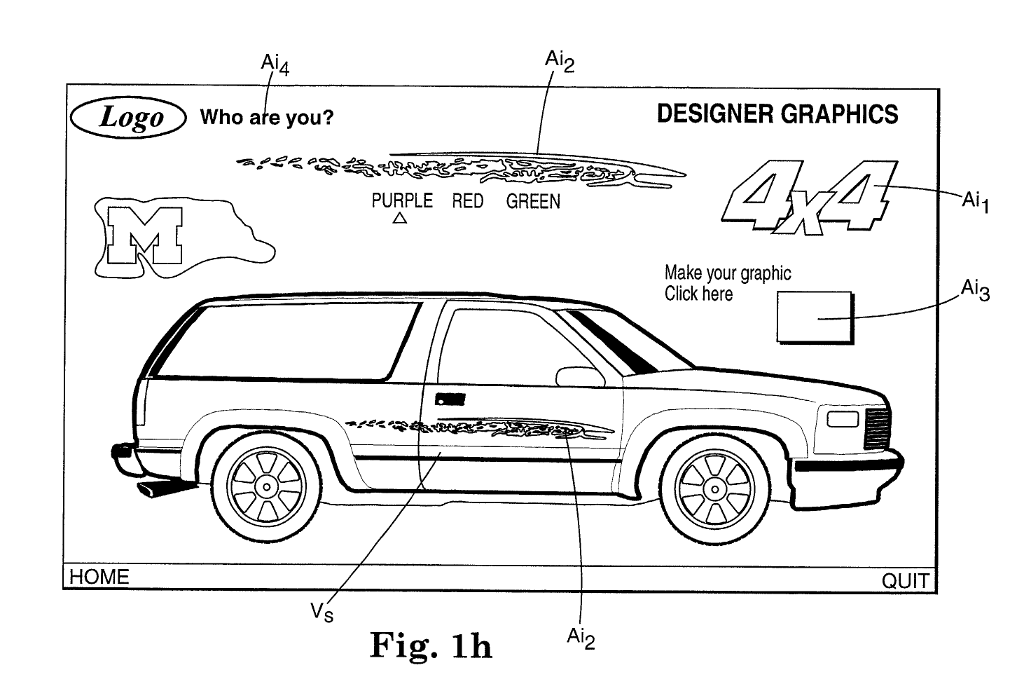

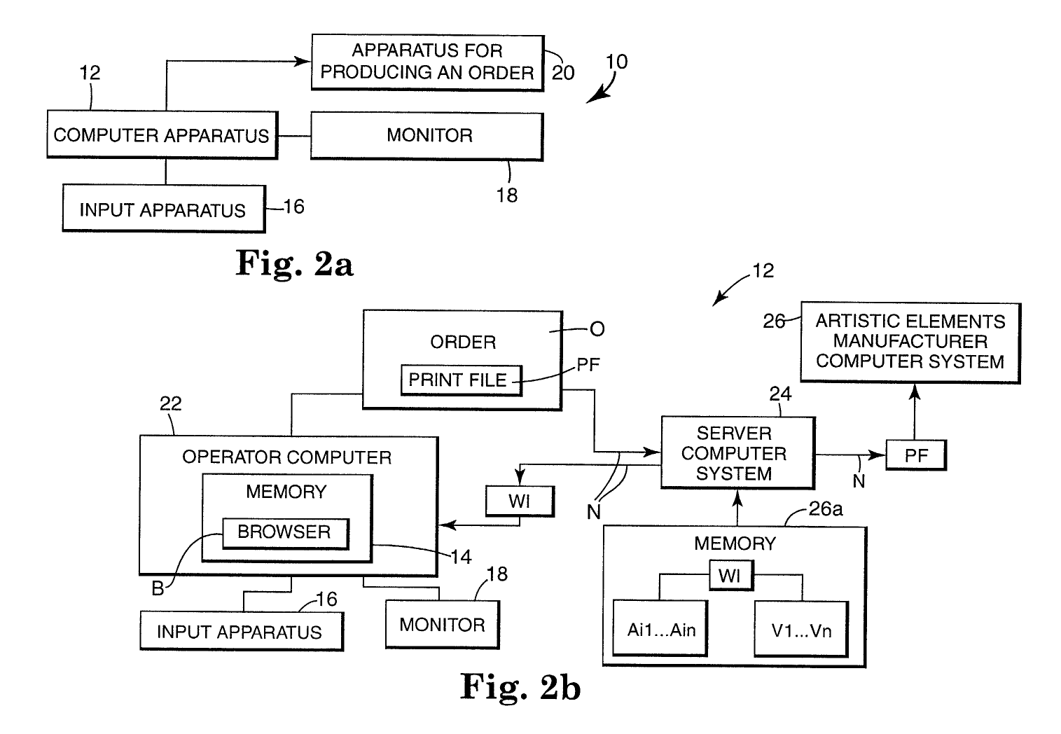

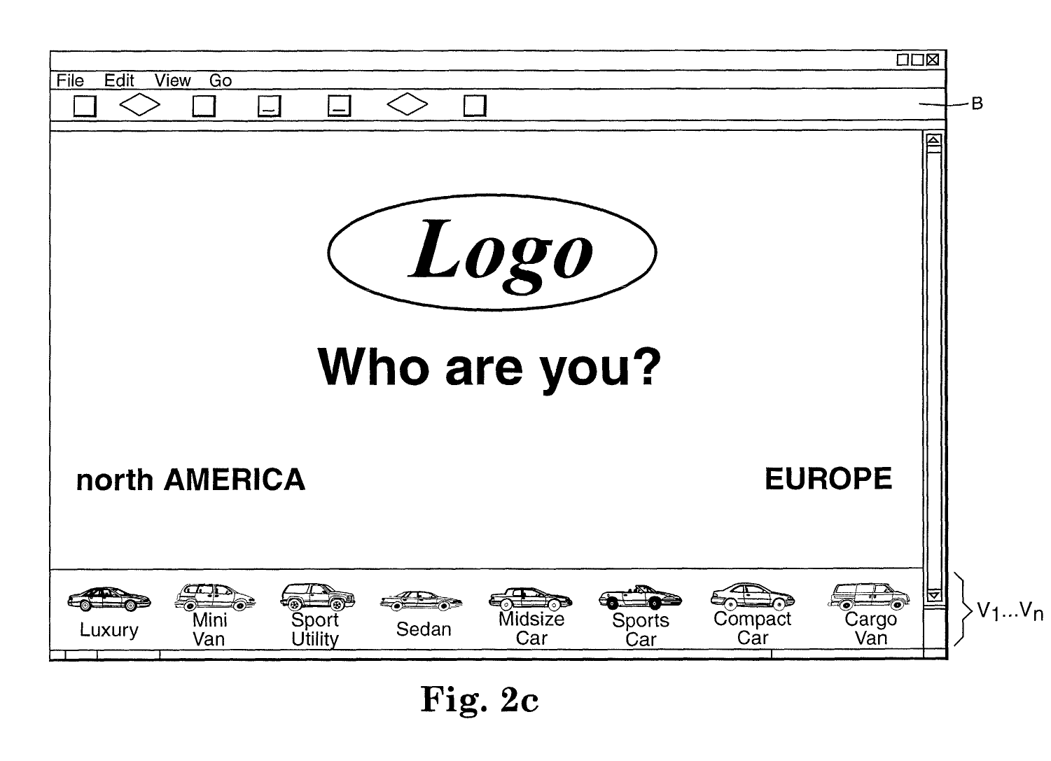

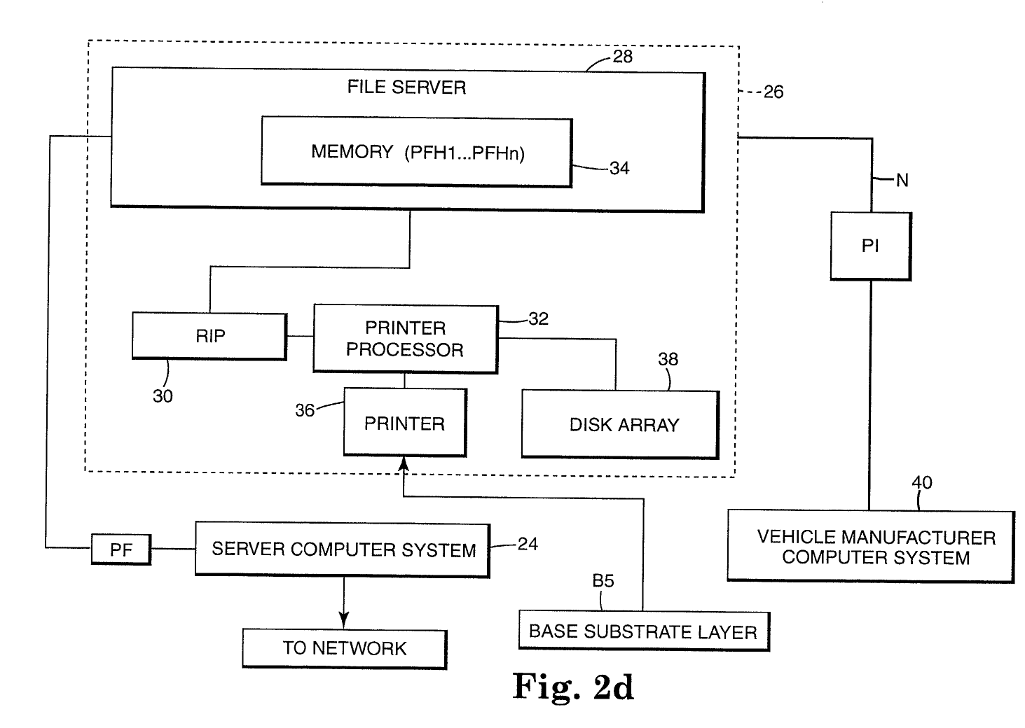

A second embodiment of a system 10 for designing and manufacturing a customized artistic element package P to be applied to a vehicle is illustrated in FIG. 2a. This system 10 comprises a computer apparatus 12, an input apparatus 16, at least one monitor 18 and apparatus for producing the order 20. The at least one monitor 18 serves to display the selected one or more initial artistic element representations Ai₁ . . . Aiₙ and the vehicle representations V₁ . . . Vₙ. The input apparatus 16 is coupled to the computer apparatus 12 for permitting the selection of one or more of the initial artistic element representations Ai₁ . . . Aiₙ for placement on a selected vehicle representation Vₛ to create initially a composite representation Vₛ(Ai₁ . . . Aiₙ) (see FIG. 1a). As described above, the input apparatus 16 also allows the customer to design a customized artistic element package P comprised of final artistic element representations P(Af₁ . . . Af_{f} ) using the selected one or more initial artistic element representations Ai₁ . . . Aiₙ .

In one version of this embodiment, as shown in FIG. 2b, the computer apparatus 12 comprises an operator computer 22 including memory 14. This operator computer 22 is connected directly or indirectly to a server computer system 24, such as through a computer network N. Preferably, the operator computer 22 is provided with a browser B, such as the NAVIGATOR product produced by NETSCAPE or the INTERNET EXPLORER product produced by MICROSOFT. This browser B is stored in memory 14 for graphical display on the monitor 18 (see the “screen shot” of FIG. 2c). Preferably, the operator computer 22 is located at an after-market detailer, a vehicle dealer, or other location, including a retail establishment maintained by an artistic elements manufacturer, but could also be located at the residence of an individual user/purchaser.

The server computer system 24 includes memory 26a for storing web site information W1 including the plurality of initial artistic element representations Ai₁ . . . Aiₙ and the at least one, and preferably a plurality of vehicle representations V₁ . . . Vₙ. Through the computer network N, the server system 24 is capable of downloading this web site information W1 into the memory 14 of the operator computer 22 for display on the monitor 18. Then, using a browser B of the type identified above or similar computer-implemented program for viewing web site information W1 in conjunction with other components that provide access to the network N, the customer may view and, if desired, manipulate the artistic element representations Ai₁ . . . Aiₙ substantially as described above, create one or more final artistic element representations Af₁ . . . Af_{f} to form a customized artistic element package P, and generate an order O. As with the first embodiment, information on the particular final artistic element representations Af₁ . . . Afₙ comprising the package P may be contained in print file information PF associated with the order and generated by the operator computer 22 along with other order information including purchaser identification information PI and final placement information specifying where each final artistic element is to be located on the vehicle, which is then transmitted across the network N to the server system 24. However, in this embodiment, the print file information PF preferably does not contain the high-resolution data representing the particular final artistic element representations Af₁ . . . Af_{f} forming the package P, since these data are large in amount and thus consume excessive amounts of bandwidth, which in some cases can delay and even preclude the sending of the print file information PF over the network N.

The network N employed for transmitting the web site information WI from the server system 24 to the operator computer 22, or from the operator computer 22 back to the server system 24 is preferably the Internet/World Wide Web. To access the Web site information WI, the user/customer types a particular uniform resource locator (URL) into the browser B, as is well known in the art. Alternatively, the server system 24 may be part of an “intranet,” or a private network of computers maintained by a particular artistic elements manufacturer. The “intranet” may be accessed by a user using a computer which is not a part of the manufacturer's private computer network through the Internet/World Wide Web by using a URL in conjunction with a password to get past the firewall or like security device protecting the intranet from unauthorized entry. The latter arrangement is commonly known as an “extranet,” since it embodies aspects of both the Internet and an intranet. In the case where the operator computer 22 is located at a vehicle dealership or after-market detailer, the “extranet” is the most preferred manner of implementing the system of the present invention. However, the “extranet” arrangement is not particularly well-suited for use among the public generally, since it may allow unwanted users to access the intranet of the artistic elements manufacturer and perhaps create security problems. Also, by requiring a password, the extranet arrangement allows for traffic to the server system 24 to be controlled and limited to a certain number of users. This ensures that each online customer may simultaneously select and design a particular custom artistic elements package P without significant delays caused by server 24 “overload,” which should result in a more efficient and overall pleasant experience. It is also possible, of course, that the operator computer 22 could be a part of the network forming the intranet of the artistic elements manufacturer, such as when the order is placed at a retail store, outlet, or like business location owned or run by the artistic elements manufacturer itself.

Once the print file information PF is created, the operator computer 22 is capable of transmitting the order information simultaneously as a whole or in parts to the server computer system 24. The server system 24 then preferably sends the print file information PF (e.g., an initial artistic element representation code, information on any custom scaling, cutting, or rotating), final placement information and purchaser identification information PI for the order O over a network N to an artistic elements manufacturer computer system 26, which also forms a part of the computer apparatus 12. As shown in FIG. 2d and in the case of flat graphics, the artistic elements manufacturer computer system 26 preferably comprises a file server 28 for receiving the order information including the print file information PF, a raster image processor 30 and a printer processor 32 coupled to or otherwise forming an integral part of a printer 36 or like printing apparatus. The file server 28 includes memory 34 for storing a plurality of high-resolution print files PFH₁ . . . PFHₙ. The file server 28 receives the print file information PF from the server computer system 24. The print file information PF identifies one or more high-resolution print files PFH₁ . . . PFHₙ stored in memory 34 that generally correspond to one or more final artistic element representations Af₁ . . . Af_{f} defining the customized package P. The file server 28 then retrieves the one or more corresponding high-resolution print files PFH₁ . . . PFHₙ from memory 34 and makes any adjustments necessary to the data comprising each retrieved high-resolution print file such that any customized adjustments made by the user (size adjustments, cuts, crops, rotations, etc.) are implemented prior to printing.

Once the selections are complete and any necessary adjustments are made to the data, the server 28 transmits the retrieved high-resolution print files PFH₁ . . . PFHₙ to the raster image processor 30. The raster image processor 30 converts the one or more high-resolution print files PFH₁ . . . PFHₙ into one or more bit-mapped images and provides the image data to the printer processor 32, which, in turn, stores the data on a disk array 38, discussed further below. The printer processor 32 then directs the image data to the printer 36. The printer 36 then prints the one or more bit-mapped images onto a base substrate layer BS or the like, such as a thin, adhesive-backed polyvinyl chloride or like material. An example of an adhesive-backed polyvinyl chloride material is one which is commercially available from 3M under the product designation “3M High Performance Automotive Grade Film (Scotchcal™)”.

The printer 36 may comprise a conventional digital color printer one of which is available from Xeikon NV, Mortsel, Belgium, under the product designation “Xeikon DCP 32D.”

The artistic elements manufacturer computer system 26 is preferably capable of receiving a large amount of bit-mapped data to allow for the continuous printing of discrete images on a continuous (roll) base substrate layer BS to occur. In the most preferred embodiment, the bit-mapped image data is stored on the disk array 38, noted above, comprising two or more fixed disk drives. One such array 38 is commercially available from Barco Group, Paris, France, under the product designation “Print Streamer.” This array 38 is coupled to the printer processor 32, and preferably includes a sufficient amount of storage space (i.e., 64 gigabytes or more) for receiving and storing enough bit-mapped image data to allow the printer 36 to continuously print a plurality of the bit-mapped images on at least 23,000 inches of a base substrate layer BS (see below). By doing so, it is possible for the printer 36 to generate multiple artistic element packages P sequentially or simultaneously on a continuous base substrate BS, which may then be cut into one or more packages P. Although this array 38 is preferred for continuous printing, those of skill in the art will recognize that other types of temporary data storage devices having relatively fast access times, including arrays of random-access memory (RAM), may be used to perform a similar function at a larger or smaller scale.

In this embodiment, the computer apparatus 12 may also include a vehicle manufacturer computer system 40 capable of being interconnected with the server system 26. The server system 26 sends the print file information PF, the final placement information and the purchaser information PI for the order O over a network N, such as the Internet, to the vehicle manufacturer computer system 40 after receiving the order from the operator computer 22. The vehicle manufacturer is then provided with a record of the order O and instructions as to where the final artistic elements are to be located on the vehicle.

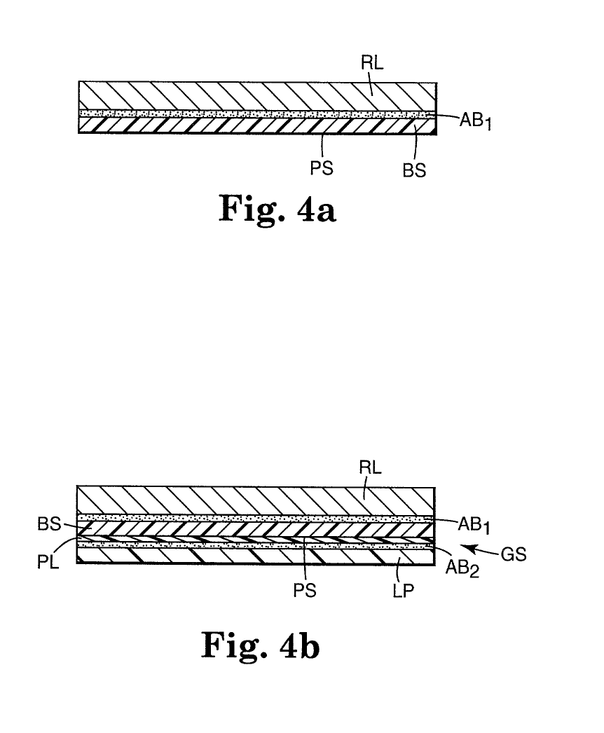

Turning now to the artistic element package P manufacturing procedure as it pertains to flat graphics, the printer 36 prints the final artistic element representations Af₁ . . . Af_{f} on the base substrate layer BS. As shown in FIGS. 4a and 4b, the base substrate layer BS preferably also has an adhesive-backed surface AB₁ covered by a release liner RL. This release liner RL is peeled away to expose the pressure sensitive adhesive backing AB₁ that ultimately serves to affix the cut-out graphic printed on the base substrate BS to a vehicle.

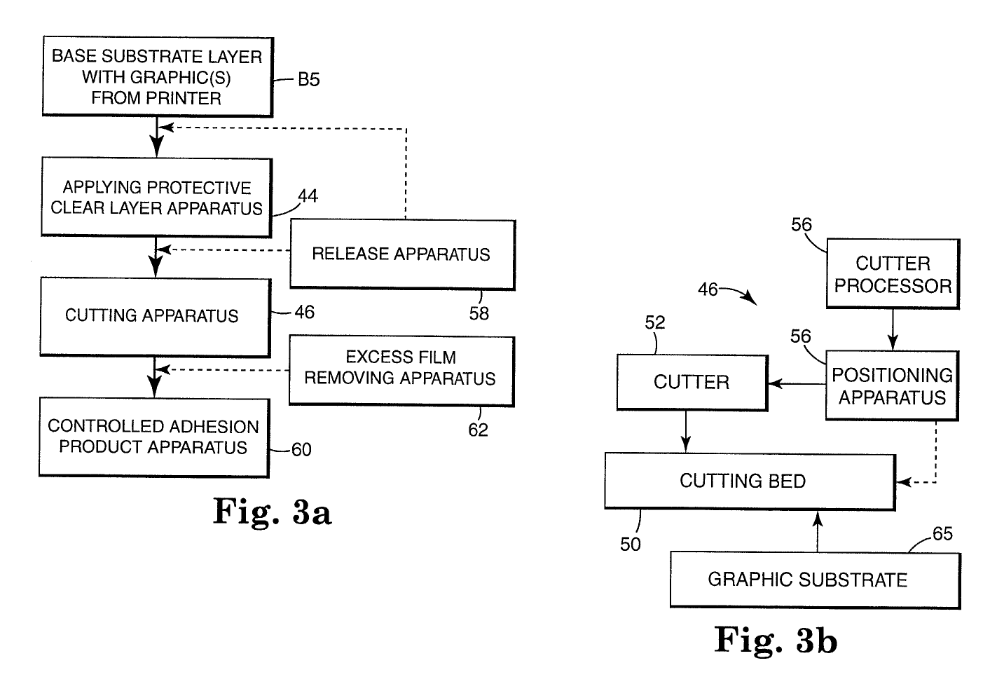

As shown in FIG. 3a, the apparatus for producing the order 20 comprises an applying protective clear layer apparatus 44 and a cutting apparatus 46. As explained above, the printer 36 prints one or more final artistic element representations Af₁ . . . Afₙ defining the customized package P on a first side of a base substrate layer BS, thereby producing a first printed surface PS. The applying apparatus 44 then applies a protective clear layer PL on the first printed surface PS of the printed base substrate layer BS to produce a graphic substrate GS (see FIG. 4b). The apparatus 44 for applying a protective layer PL on the first printed surface PS of the printed base substrate layer BS may comprise a spray-line apparatus in a substantially clean environment for spraying on the first printed surface PS a clear coat material, such as a high performance urethane protective material, one of which is commercially available from 3M under the product designation 3M HPC 37. After spraying, the sprayed layer is baked in an over, heated to approximately 290° F., for three to four minutes to complete the crosslinking reaction. Alternatively, the apparatus 44 may comprise a screen-printing apparatus to apply a clear coat material such as a urethane protective material, one of which is commercially available from 3M under the product designation “3M HPC 37 LT.” After screen printing, the screen-printed BS layer is baked in an oven, heated to 250° F., for about four minutes to complete the crosslinking reaction. The apparatus 44 may also comprise an apparatus for applying a substantially clear film, such as triple layer clear coat film comprising a thermoplastic urethane base layer provided with a pressure-sensitive adhesive layer thereon and an upper layer comprising a fully cured thermoset urethane film. One such triple layer film is commercially available from 3M under the product designation “NPE 1194.”

Once the protective film or coating is applied (and solidifies or cures, if sprayed on), the cutting apparatus 46 is used to cut the graphic substrate to separate one or more finalized artistic elements from a remaining portion of the graphic substrate GS. The cutting apparatus 46 may comprise a cutting bed 50 adapted to receive the graphic substrate GS, a cutter 52, and a positioning apparatus 54 preferably coupled to the cutter 52 for moving it relative to the cutting bed 50. Alternatively, the positioning apparatus 54 may move the cutting bed 50 relative to the cutter 52, or move the cutter 52 and the cutting bed 50 relative to each other. In any case, a cutter processor 56 is coupled to the file server 28 and the positioning apparatus for providing movement commands in accordance with a cut file, stored in the file server 28, see FIG. 2d, , to the positioning apparatus 54 to effect the cutting of the graphic substrate GS to separate the one or more finalized artistic elements from the remaining portion of the graphic substrate. A suitable type of electronic cutter could be one selected from the group of: (1) the Aristomat Model No. 1317 or 1625, manufactured by Aristo of Hamburg, Germany (www.aristo.de) and sold in North America by Euro-tech of Englewood, Colo. (www.europlotter.com); or (2) Model L2500 or XL 2500 manufactured by Zünd of Altstätten, Switzerland (www.zund.com) and sold in North America by Mikkelsen Graphic Engineering, Inc. of Lake Geneva, Wis. (www.mge-us.com).

Preferably, the cutter apparatus 46 is capable of using currently available technology for automatically cutting the graphics from the graphic substrate GS, such as by using “machine vision.” In “machine vision,” a camera or other sensor is used to locate automatically bar codes printed on the graphic substrate GS identifying each artistic element representation Af₁ . . . Af_{f} (such as by defining the purchaser information for each artistic element representation), as well as one or more (usually four) targets provided along the edges of each representation on the graphic substrate GS. To facilitate the use of this technology, the printer 36 may print the bar codes and/or registration indicia on the base substrate layer BS for each of the one or more final artistic element representations Af₁ . . . Af_{f}. The camera then scans the bar codes and determines which representation is present. The cut file for this specific representation is then retrieved from the file server 28. Then, after the camera locates and identifies the registration indicia for each final artistic element representation Af, the cutting apparatus 46 automatically cuts the graphic substrate GS to separate the finalized artistic element from the remaining portion of the graphic substrate GS. Prior to cutting, the cutter processor 56 may compare the detected location of the registration indicia on the substrate with the location where each indicia was supposed to be printed, as indicated by the cut file, to determine whether any stretching or shrinking occurred during or after printing. If stretching or shrinking has occurred, the processor 56 will make appropriate corrections so that each finalized artistic element is accurately cut along appropriate locations.

In the case where the base substrate layer BS does not include an adhesive layer and a release liner (typically, the base substrate layer BS is provided by a vendor having an adhesive layer and a release liner), the apparatus 20 for producing the order may also include an apparatus 58 for applying an adhesive layer, such as a pressure sensitive adhesive, and a release liner RL to the base substrate layer BS.

In either case where the base substrate layer BS is supplied with an adhesive layer and a release liner or does not initially include an adhesive layer and a release liner but is subsequently provided with same, the release liner RL is peeled away prior to the application of the cut graphic to the vehicle. Preferably, the pressure sensitive adhesive allows the graphic to be removed from the vehicle at a later date without damaging the finish. A film having such a pressure sensitive adhesive layer thereon is commercially available from 3M under the product designation 3M High Performance Automotive Grade Film (Scotchcal™).”

Additionally, the apparatus for producing the order 20 may comprise apparatus 60 for applying a controlled adhesion or liner product LP, such as mask paper, over the protective clear layer PL. This controlled adhesion product LP serves not only to protect the printed graphic on the base substrate layer BS from damage during shipping, but also enhances the rigidity of this substrate layer, which is normally fabricated of very thin (2 mil) film, e.g., polyvinyl chloride film. The controlled adhesion product LP also prevents the base substrate layer BS of the graphic from stretching during shipping, as well as during application. More specifically, the paper forming the controlled adhesion product LP is provided with an adhesive backing AB₂ that creates a weaker bond than the adhesive backing AB₁ that is used to affix the graphic to the vehicle once the release liner RL is removed. During application of the graphic to the vehicle, the controlled adhesion product LP is kept on the base substrate layer BS to prevent it from stretching. Once the release liner RL is removed and the base substrate layer BS is properly positioned on the vehicle, the controlled adhesion product LP may be peeled from the graphic. The bond created by the adhesive backing AB₂ is sufficiently weak such that the controlled adhesion product LP may be removed without disturbing the adhesive bond formed between the adhesive backing AB₁ on the base substrate layer BS and the vehicle.

The apparatus for producing the order 20 may also include apparatus 62 for removing the remaining portion of the graphic substrate GS from the one or more finalized graphics after cutting (not shown), which is commonly referred to as “weeding.” In one example of a “weeding” apparatus, a rotating shaft is suspended above the graphic substrate GS and the graphic substrate GS is pulled under the rotating shaft. The excess portion is attached to the rotating shaft and all contiguous portions of the excess film are automatically removed. Non-contiguous film which remains (the center of a letter “O” or “D” for example) must be removed in a manual operation.

When one or more of the finalized artistic elements comprise a dimensional graphic, any conventional process and apparatus used to manufacture dimensional graphics may be employed to make these elements.

In addition to the various embodiments of a system 10 for producing an artistic element package P described above, a related process is also disclosed for generating an order for a customized artistic element package to be applied to a vehicle. The process includes creating a database of a plurality of initial artistic element representations and at least one, and preferably a plurality of vehicle representations. The user selects one or more of the initial artistic element representations for placement at one or more locations on a selected vehicle representation, which are then displayed on a monitor or other visual display device.

As explained above, the user may interactively design a customized artistic element package using the selected one or more initial artistic element representations. Designing the customized artistic element package may include moving one of the one or more selected initial artistic element representations to another location on the selected vehicle representation, rotating one of the one or more selected initial artistic element representations, modifying the size or shape of one of the one or more selected initial artistic element representations and/or clipping or trimming one of the one or more selected initial artistic element representations.

Once the particular representations are selected, an order for the artistic element package may be generated. The order is preferably electronically transmitted to an artistic elements manufacturer, but may also be sent by mail or other courier on an electronic storage medium, such as a disk. The transmitted order may comprise print file information for one or more final artistic element representations defining the customized artistic element package, final placement information specifying where each final artistic element is to be positioned on the vehicle, and purchaser information such as dealership and vehicle identification information.

In an alternate embodiment, the process also includes producing a package of artistic elements, such as is commonly done by an artistic elements manufacturer or the like. This may include printing onto a first side of a base substrate layer graphical information for each of one or more final artistic element representations defining the customized package to produce a first printed surface. Then, a protective layer is applied on the first printed surface of the base substrate layer to produce a graphic substrate. To separate one or more finalized artistic elements from a remaining portion of the graphic substrate, the graphic substrate is cut, either by hand or using a cutter of the type identified in the foregoing description. Once cut, the one or more separated, finalized elements comprise one or more flat graphics.

Preferably, the base substrate layer has an adhesive-backed surface such that it can be affixed to the vehicle. In this case, a release liner is applied over the adhesive-backed surface of the base substrate layer. In one embodiment, the base substrate layer has a releasable adhesive backed surface that permits the one or more separated, finalized elements to be easily removed after being applied to a vehicle. A protective layer may also be applied over the printed graphic, and a paper mask layer or the like provided over the protective layer to make the graphic easier to manipulate and to prevent stretching or shrinking from occurring.

When the order is generated at a vehicle dealership, it may be forwarded to a vehicle manufacturer together with an order for a vehicle. In a first embodiment of the process described thus far, the produced artistic element package is shipped from the artistic elements manufacturer to the vehicle manufacturer for application of the produced package to the ordered vehicle at the vehicle manufacturer. In a second embodiment, the produced artistic element package is instead shipped to the vehicle dealer along with the vehicle originating from the vehicle manufacturer. Then, the graphics comprising the package can be applied to the ordered vehicle at the dealership. In yet a third embodiment, the produced artistic element package is shipped to the dealership for application to the ordered vehicle at the dealership. In any case, payment for the order may be made directly to the dealership or to the artistic elements manufacturer. When payment is made to the dealership, it is made either when the vehicle is ordered or received.

It is also contemplated that the order may be generated at either a vehicle dealership or the residence of an individual purchaser. In either case, the order for the artistic element package may be sent to a vehicle manufacturer together with an order for a vehicle. In this embodiment, the order for the package is forwarded from the vehicle manufacturer directly to an artistic elements manufacturer. The vehicle manufacturer may make payment directly to the artistic elements manufacturer and then bill the dealer accordingly.

The foregoing description of preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A system for designing a customized artistic element package to be applied to a vehicle comprising:
computer apparatus including memory for storing a plurality of initial artistic element representations and at least one representation of a vehicle;
input apparatus coupled to said computer apparatus for permitting one or more of said initial artistic element representations to be selected for placement on said vehicle representation;
at least one monitor coupled to said computer apparatus for displaying said selected one or more initial artistic element representations placed on said vehicle representation; and
said input apparatus further permitting one or more final artistic element representations to be designed with input from a person using said selected one or more initial artistic element representations, said one or more final artistic element representations defining a customized artistic element package.

2. A system as set forth in claim 1, wherein said computer apparatus stores a plurality of vehicle representations in said memory such that a desired one of said vehicle representations may be selected via said input apparatus for viewing on said monitor.

3. A system as set forth in claim 1, wherein said input apparatus is capable of generating appropriate command signals to said computer apparatus to permit one of said selected one or more initial artistic element representations to be moved from a first location to a second location on said vehicle representation.

4. A system as set forth in claim 1, wherein said input apparatus is capable of generating appropriate command signals to said computer apparatus to permit one of said one or more initial artistic element representations to be rotated on said vehicle representation.

5. A system as set forth in claim 1, wherein said input apparatus is capable of generating appropriate command signals to said computer apparatus to permit at least one of the size and shape of at least one of said selected one or more initial artistic element representations to be modified.

6. A system as set forth in claim 1, wherein said plurality of initial artistic element representations comprise a plurality of representations of one or more of dimensional graphics and flat graphics.

7. A system as set forth in claim 1, wherein said input apparatus additionally permits an order for said artistic element package to be generated and said computer apparatus electronically transmits print file and purchaser identification information for said order to an artistic elements manufacturer.

8. A system as set forth in claim 7, wherein said input apparatus is capable of generating appropriate command signals to said computer apparatus to input a request for pricing information for said package prior to generating said order.

9. A system as set forth in claim 7, wherein said input apparatus further permits a vehicle identification number and a dealer identification number to be input into said computer apparatus, said vehicle and dealer identification numbers defining said purchaser identification information.

10. A system as set forth in claim 1, wherein said one or more final artistic element representations comprise said one or more initial artistic element representations placed at one or more predefined locations on said vehicle, said initial artistic element representations being located at said one or more predefined locations on said vehicle when initially selected and placed on said vehicle representation.

11. A system for designing and manufacturing a customized artistic element package to be applied to a vehicle comprising:
computer apparatus including memory for storing a plurality of initial artistic element representations and at least one representation of a vehicle;
input apparatus coupled to said computer apparatus for permitting one or more of said initial artistic element representations to be selected for placement on said vehicle representation, said input apparatus further permitting a customized artistic element package to be designed using said selected one or more initial artistic element representations, and additionally permitting an electronic order for said package to be generated;
at least one monitor coupled to said computer apparatus for displaying said selected one or more initial artistic element representations placed on said vehicle representation; and
apparatus for producing said order.

12. A system as set forth in claim 11, wherein said computer apparatus comprises:
an operator computer provided with a browser and being coupled to said input apparatus and said monitor, said customized artistic element package being designed using said operator computer; and
a server computer system including memory for storing web site information including said plurality of initial artistic element representations and said at least one vehicle representation, said server system being capable of downloading said web site information to said operator computer for viewing by an operator at said monitor, and said operator computer being capable of sending print file information for said order to said server computer system.

13. A system as set forth in claim 12, wherein said operator computer is capable of receiving one or more customer-generated print files and transmitting said one or more customer-generated print files to said server system.

14. A system as set forth in claim 12, wherein said operator computer is located at one of a vehicle dealership, an after-market detailer, and the residence of an individual purchaser.

15. A system as set forth in claim 12, wherein said computer apparatus further comprises an artistic elements manufacturer computer system which is capable of being interconnected with said server system, said server system sending said print file information for said order to said artistic elements manufacturer computer system after receiving said print file information from said operator computer.

16. A system as set forth in claim 15, wherein said artistic elements manufacturer computer system comprises:
a file server including memory storing a plurality of high resolution print files, said file server receiving said print file information from said server system, said print file information identifying one or more of said high resolution print files which correspond to one or more final artistic element representations defining said customized package, said file server retrieving said one or more corresponding high resolution print files;
a raster image processor receiving said one or more high resolution print files from said file server and converting said one or more high resolution print files into one or more bit-mapped images; and
a printer processor coupled to a printer, receiving said one or more bit-mapped images from said raster image processor and generating print commands to said printer to effect printing of said one or more bit-mapped images on a base substrate layer.

17. A system as set forth in claim 16, wherein said artistic elements manufacturer computer system further includes a disk array coupled to said printer processor for receiving and storing sufficient bit-mapped image data so as to permit said printer to print continuously a plurality of said bit-mapped images on said base substrate layer.

18. A system as set forth in claim 17, wherein said disk array stores sufficient bit-mapped image data so as to permit said printer to print continuously a plurality of said bit-mapped images on at least 23,000 inches of said base substrate layer.

19. A system as set forth in claim 12, wherein said computer apparatus further comprises a vehicle manufacturer computer system which is capable of being interconnected with said server system, said server system sending purchaser information for said order to said vehicle manufacturer computer system after receiving said order from said operator computer.

20. A system as set forth in claim 19, wherein said operator computer being capable of sending a vehicle identification number and a dealer identification number to said server system, said vehicle and dealer identification numbers defining said purchaser information.

21. A system as set forth in claim 11, wherein said computer apparatus comprises a workstation computer coupled to said input apparatus and said monitor, said workstation computer including said memory for storing said plurality of representations of initial artistic elements and said at least one representation of a vehicle.

22. A system as set forth in claim 11, wherein said computer apparatus is capable of receiving one or more customer-generated print files.

23. A system as set forth in claim 22, wherein said one or more customer-generated print files comprise one or more high-resolution print files.

24. A system as set forth in claim 22, wherein said one or more customer-generated print files are transmitted to said computer apparatus from a customer computer system.

25. A system as set forth in claim 11, further including a base substrate layer having on a first side one or more printed graphics corresponding to each of one or more final artistic element representations defining said customized package, said first side defining a first printed surface, and wherein said apparatus for producing said order comprises:
apparatus for applying a protective layer on said first printed surface of said printed base substrate layer to produce a graphic substrate; and
apparatus for cutting said graphic substrate to separate one or more finalized artistic elements from a remaining portion of said graphic substrate, said one or more separated, finalized elements comprising one or more flat graphics.

26. A system as set forth in claim 25, wherein said base substrate layer has an adhesive back surface and said apparatus for producing said order further comprises:
apparatus for applying a release liner over said adhesive back surface of said base substrate layer;
apparatus for applying a controlled adhesion product over said protective layer; and
apparatus for removing the remaining portion of said graphic substrate from said one or more finalized elements.

27. A system as set forth in claim 25, wherein said apparatus for cutting can automatically cut said graphic substrate into a desired pattern.

28. A system as set forth in claim 25, further comprising a printing apparatus or printing said graphics on said base substrate layer, said printing apparatus further printing registration indicia on said base substrate layer for each of said one or more finalized artistic elements and said apparatus for cutting automatically cuts said graphic substrate to separate one of said one or more finalized artistic elements from said remaining portion of said graphic substrate after locating and identifying said registration indicia for said one finalized artistic element.

29. A system as set forth in claim 25, wherein said cutting apparatus comprises:
a cutting bed adapted to receive said graphic substrate;
a cutter;
positioning apparatus for at least one of moving said cutter relative to said cutting bed, moving said cutting bed relative to said cutter, and moving said cutter and said cutting bed relative to each other; and
a cutter processor coupled to said positioning apparatus for providing movement commands to said positioning apparatus to effect the cutting of said graphic substrate to separate said one or more finalized artistic elements from said remaining portion of said graphic substrate.

30. A system as set forth in claim 25, wherein said apparatus for applying a protective layer on said first printed surface of said printed base substrate layer to produce said graphic substrate comprises one of spray-line apparatus in a substantially clean environment, screen-printing apparatus and apparatus for applying a substantially clear film for protection of said printed base substrate layer.

31. A process for generating an order for a customized artistic element package to be applied to a vehicle comprising:
creating a database of a plurality of initial artistic element representations and at least one representation of a vehicle;
selecting one or more of the initial artistic element representations for placement at one or more locations on the vehicle representation;
displaying on at least one monitor the selected one or more initial artistic element representations placed on the vehicle representation;
designing interactively with a person a customized artistic element package using the selected one or more initial artistic element representations; and
generating an order for the artistic element package.

32. A process as set forth in claim 31, further comprising the steps of:
creating a data base of a plurality of vehicle representations; and
selecting one of the vehicle representations for receiving the one or more initial artistic element representations.

33. A process as set forth in claim 32, wherein said designing step comprises moving one of the one or more selected initial artistic element representations to another location on the selected vehicle representation.

34. A process as set forth in claim 31, wherein said designing step comprises rotating one of the one or more selected initial artistic element representations.

35. A process as set forth in claim 31, wherein said designing step comprises modifying the size of one of the one or more selected initial artistic element representations.

36. A process as set forth in claim 31, wherein said designing step comprises modifying the shape of one of the one or more selected initial artistic element representations.

37. A process as set forth in claim 31, wherein said designing step comprises clipping one of the one or more selected initial artistic element representations.

38. A process as set forth in claim 31, wherein the order is electronically transmitted to an artistic elements manufacturer.

39. A process as set forth in claim 38, wherein the transmitted order comprises print file information for one or more final artistic element representations defining said customized artistic element package and including information regarding placement of the one or more finalized artistic elements on the vehicle, and optionally, one or more scale factors, and purchaser identification information including vehicle identification information and dealer identification information.

40. A process for designing and manufacturing a customized artistic element package to be applied to a vehicle comprising:
creating a database of a plurality of initial artistic element representations and at least one representation of a vehicle;
selecting one or more of the initial artistic element representations for placement at one or more locations on the vehicle representation;
displaying on at least one monitor the selected one or more initial artistic element representations placed on the vehicle representation;
designing interactively with a person a customized artistic element package using the selected one or more initial artistic element representations;
generating an order for the artistic element package; and
producing the artistic element package.

41. A process as set forth in claim 40, wherein said step of producing the package comprises the steps of:
printing onto a first side of a base substrate layer graphical information for each of one or more final artistic element representations defining the customized package to produce a first printed surface;
applying a protective layer on the first printed surface of the base substrate layer to produce a graphic substrate; and
cutting the graphic substrate to separate one or more finalized artistic elements from a remaining portion of the graphic substrate, the one or more separated, finalized elements comprising one or more flat graphics.

42. A process as set forth in claim 41, wherein the base substrate layer has an adhesive back surface and said step of producing the package further comprises the steps of:
applying a release liner over the adhesive back surface of the base substrate layer; and,
applying a controlled adhesion product over the protective layer.

43. A process as set forth in claim 40, wherein the base substrate layer has a releasable adhesive back surface which permits the one or more separated, finalized elements to be easily removed after being applied to a vehicle.

44. A process as set forth in claim 40, wherein the order is generated and the artistic element package is produced within five days.

45. A process as set forth in claim 40, wherein the order comprises print file information and purchaser identification information including a vehicle identification number, the purchaser information being used for identifying and tracking the order.

46. A process as set forth in claim 40, wherein the order is generated at one of a vehicle dealership, an after-market detailer, and the residence of an individual purchaser.

47. A process as set forth in claim 46, further comprising the step of forwarding the order to an artistic elements manufacturer.

48. A process as set forth in claim 47, wherein the order is generated at a vehicle dealership and further comprising the step of forwarding the order for the artistic element package to a vehicle manufacturer together with an order for a vehicle.

49. A process as set forth in claim 48, further comprising the step of shipping the produced artistic element package from the artistic elements manufacturer to the vehicle manufacturer for application of the produced package to the ordered vehicle at the vehicle manufacturer.

50. A process as set forth in claim 48, further comprising the steps of:
shipping the produced artistic element package to the vehicle manufacturer; and
shipping the ordered vehicle with the produced artistic element package to the dealership such that the artistic element package can be applied to the ordered vehicle at the dealership.

51. A process as set forth in claim 48, further comprising the step of shipping the produced artistic element package to the dealership for application of the ordered package to the ordered vehicle at the dealership.

52. A process as set forth in claim 48, further comprising the step of making payment for the order to one of the dealership and the artistic elements manufacturer.

53. A process as set forth in claim 52, wherein when the payment is made to the dealership the payment is made at one of the time when the vehicle is ordered and received.

54. A process as set forth in claim 46, further comprising the step of shipping the produced artistic element package to the location where the order was generated.

55. A process as set forth in claim 54, further comprising the step of making payment for the order at one of the time when the order is generated and when the shipped package is received at the location where the order was generated.

56. A process as set forth in claim 46, wherein the order is generated at one of a vehicle dealership and the residence of an individual purchaser and further comprising the step of forwarding the order to a vehicle manufacturer together with an order for a vehicle.

57. A process as set forth in claim 56, further comprising the step of forwarding the package order from the vehicle manufacturer to an artistic elements manufacturer.

58. A process as set forth in claim 57, further comprising the step of said vehicle manufacturer making payment for the package order directly to the artistic elements manufacturer.
